(19) United States
(12) Patent Application Publication
(10) Pub. No.: US 2026/0063068 A1
(43) Pub. Date: Mar. 5, 2026

(54) EVAPORATOR SYSTEM WITHIN AN INNER FIXED STRUCTURE OF AN AIRCRAFT PROPULSION SYSTEM

(71) Applicant: RTX CORPORATION, Farmington, CT (US)

(72) Inventor: Jesse M. Chandler, S. Windsor, CT (US)

(21) Appl. No.: 18/760,285

(22) Filed: Jul. 1, 2024

(51) Int. Cl. F02C 3/30

(52) U.S. Cl. CPC F02C 3/30; F05D 2220/323

(57) ABSTRACT

An aircraft propulsion system includes a core engine that includes a compressor, combustor, and turbine section, an inlet airflow is compressed and communicated to the combustor, mixed with fuel, and ignited to generate an exhaust gas flow that is expanded through the turbine section, a propulsor that is driven about a propulsor axis by the core engine, an exhaust duct defines a flow path for the exhaust gas flow, the exhaust duct includes a central portion and at least one radial portion, a condenser assembly where water is condensed from the exhaust gas flow that is received through the exhaust duct, and an evaporator system where heat from the exhaust gas flow is used to transform water from the condenser assembly into a steam flow for communication to the core engine. The evaporator system includes a first stage separate from a second stage disposed within the central portion of the exhaust duct.

### TECHNICAL FIELD

The present disclosure relates generally to an evaporator system for an aircraft propulsion system.

### BACKGROUND

An aircraft propulsion system typically includes a gas turbine engine with a fan section, a compressor section, a combustor section, and a turbine section. Air entering the compressor section is compressed and delivered into the combustion section where it is mixed with fuel and ignited to generate a high-energy exhaust gas flow. Some energy in the high energy exhaust flow is recovered as it is expanded through a turbine section. Even with the use of alternate fuels, a large amount of energy in the form of heat is simply exhausted from the turbine section to the atmosphere. Steam injection can provide improved propulsive efficiencies. Water recovered from the exhaust gas flow may be transformed into steam using thermal energy from the exhaust gas flow. Water recovery and steam generation are performed in heat exchangers that require relatively large areas for the transfer of thermal energy. The large heat exchangers present a challenge for incorporation into an aircraft propulsion system.

### SUMMARY

An aircraft propulsion system according to an exemplary embodiment of this disclosure, among other possible things includes a core engine that includes a compressor, combustor, and turbine section, an inlet airflow is compressed and communicated to the combustor, mixed with fuel, and ignited to generate an exhaust gas flow that is expanded through the turbine section, a propulsor is driven about a propulsor axis by the core engine, an exhaust duct defines a flow path for the exhaust gas flow, the exhaust duct includes a central portion and at least one radial portion, a condenser assembly where water is condensed from the exhaust gas flow that is received through the exhaust duct, and an evaporator system where heat from the exhaust gas flow is used to transform water from the condenser assembly into a steam flow for communication to the core engine. The evaporator system includes a first stage separate from a second stage that is disposed within the central portion of the exhaust duct.

In a further embodiment of the foregoing aircraft propulsion system, the first stage is disposed within a first evaporator plane that is disposed at a first angle relative to an engine longitudinal axis.

In a further embodiment of any of the foregoing aircraft propulsion systems, the second stage is disposed at a second angle relative to the engine longitudinal axis. The first angle is different than the second angle.

In a further embodiment of any of the foregoing, the aircraft propulsion system further includes an inner fixed structure and the central portion of the exhaust duct includes the first stage and the second stage of the evaporator system is disposed within the inner fixed structure.

In a further embodiment of any of the foregoing aircraft propulsion systems, a flow path for the exhaust gas flow within the central portion of the exhaust duct includes a first radial direction through the second stage and a second radial direction portion through the first stage.

In a further embodiment of any of the foregoing aircraft propulsion systems, the second stage includes a superheater where a steam flow is heated by the exhaust gas flow.

In a further embodiment of any of the foregoing aircraft propulsion systems, the evaporator system further includes an outer stage for heating water that is recovered from the exhaust gas flow. The outer stage is spaced radially apart from the first stage and the second stage.

In a further embodiment of any of the foregoing aircraft propulsion systems, the condenser assembly includes a plurality of condenser pairs where water is condensed from an exhaust gas flow.

In a further embodiment of any of the foregoing, the aircraft propulsion system includes a cooling air duct assembly where a portion of inlet airflow is communicated to each of the plurality of condenser pairs.

In a further embodiment of any of the foregoing, the aircraft propulsion system further includes a nacelle assembly that is disposed about the propulsor and the core engine. The plurality of condenser pairs is supported within the nacelle.

In a further embodiment of any of the foregoing, the aircraft propulsion system further includes a plurality of water separators where water from the condenser assembly is separated from the exhaust gas flow.

In a further embodiment of any of the foregoing aircraft propulsion systems, the turbine section of the core engine is engine forward of the combustor and the compressor section and an inlet duct assembly communicates a portion of the inlet airflow to an inlet that is disposed aft of the compressor section.

In a further embodiment of any of the foregoing, the aircraft propulsion system further includes a power turbine that is coupled to drive the propulsor. The power turbine is disposed engine forward of the core engine.

A steam generation system for an aircraft propulsion system according to another exemplary embodiment of this disclosure, among other possible things includes an exhaust duct that includes a central portion and at least one radial portion that defines a flow path for an exhaust gas flow, a condenser assembly where water is condensed from the exhaust gas flow that is received through the exhaust duct, and an evaporator system where heat from the exhaust gas flow is used to transform water from the condenser assembly into a steam flow for communication to a core engine flow path. The evaporator system includes a first stage separate from a second stage that is disposed within the exhaust duct.

In a further embodiment of the foregoing steam generation system, a flow path for the exhaust gas flow includes a first radial direction that communicates exhaust gas flow through the second stage and a second radial direction through the first stage. The first radial direction is opposite the second radial direction.

In a further embodiment of any of the foregoing steam generation systems, the second stage includes a superheater where a steam flow is heated by the exhaust gas flow.

In a further embodiment of any of the foregoing steam generation systems, the evaporator system further includes an outer stage for heating water that is recovered from the exhaust gas flow. The outer stage is spaced radially apart from the first stage and the second stage.

In a further embodiment of any of the foregoing steam generation systems, the condenser assembly includes a plurality of condenser pairs where water is condensed from an exhaust gas flow.

A method of operating an aircraft propulsion system according to an exemplary embodiment of this disclosure, among other possible things includes generating an exhaust gas flow with a core engine that includes a compressor, combustor, and turbine section, coupling a propulsor to a power turbine that is configured to be driven by expansion of the exhaust gas flow about a propulsor axis by the core engine, condensing water in condenser assembly, heating water from the condenser assembly in a first stage of an evaporator system with heat from the exhaust gas flow that is routed through a portion of an exhaust duct supported within an inner fixed structure, further heating a flow of heated water from the first stage of the evaporator system in a separate second stage of the evaporator assembly to generate a steam flow, the second stage receives the exhaust gas flow before the first stage, and communicating the generated steam flow to the core engine.

In a further embodiment of the foregoing, the method includes further heating the steam flow or the water flow in an outer stage that is radially spaced apart from the first stage and the second stage.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example aircraft propulsion system including an evaporator system.

FIG. 2 is a simplified schematic view of the example aircraft propulsion system of FIG. 1.

FIG. 3 is a schematic cross-section of an example evaporator system.

FIG. 4 is a schematic cross-section another example evaporator system.

### DETAILED DESCRIPTION

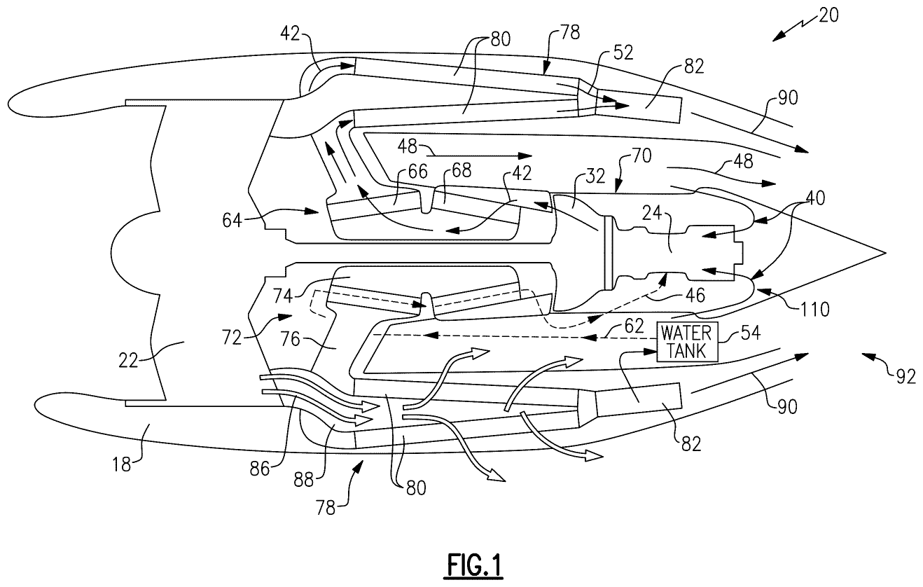

FIG. 1 schematically illustrates an aircraft propulsion system 20 that includes a multi-stage evaporator system 64 disposed within an exhaust duct 72 for vaporizing water recovered from an exhaust gas flow 42. The exhaust duct 72 includes a center portion 74 that is supported within an inner fixed structure (IFS) that is generally indicated at 70 of the system 20. The evaporator system 64 includes a first stage 66 and a second stage 68 located in the central portion 74 of the exhaust duct 72 (FIG. 1). The first stage 66 and the second stage 68 are angled relative to an axis parallel to the engine longitudinal axis A to facilitate radial routing of the exhaust gas flow 42 through each of the first stage 66 and the second stage 68 within the central portion of the exhaust duct 72.

Water is recovered from the exhaust gas flow 42 in a condenser assembly 78 including a plurality of condenser pairs 80 disposed within a nacelle 18 surrounding a propulsive fan section 22 and a core engine 24. Water recovered from the exhaust gas flow 42 is vaporized with heat from the exhaust gas flow in the evaporator system 64 and injected into the core engine 24 to improve propulsive efficiency.

The evaporator system 64 and the condenser assembly 78 include heat exchangers that transfer thermal energy. In the evaporator system 64, thermal energy from the exhaust gas flow 42 is utilized to vaporize water to generate a steam flow 46. In the condenser assembly 78, a cooling air flow 86 is utilized to cool and condense liquid from the exhaust gas flow 42. Evaporation and condensing functions may require large areas of thermal communication. The disclosed evaporator system 64 and condenser assembly 78 include features for incorporating large thermal transfer areas within the limited space available within the propulsion system 20.

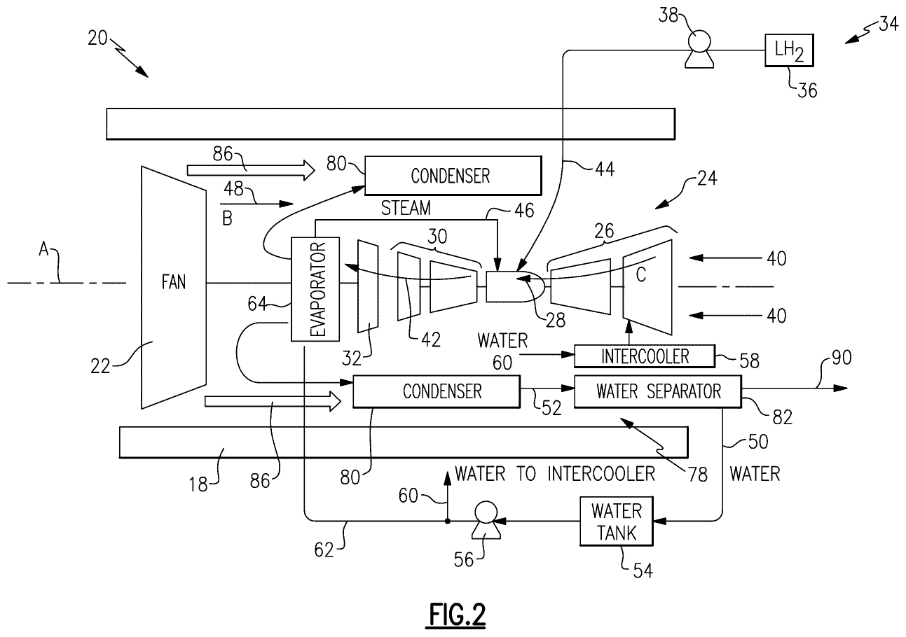

Referring to FIG. 2, with continued reference to FIG. 1, the example propulsion system 20 includes a propulsive fan 22 and a reverse core engine 24. The example core engine 24 includes a compressor section 26, a combustor section 28 and the turbine section 30 disposed along the longitudinal axis A. The turbine section 30 is disposed engine forward of the combustor 28 and the compressor section 26. A power turbine 32 is arranged forward of the turbine section 30 and is driven by the exhaust gas flow 42 from the turbine section 30. The power turbine 32 is coupled to the drive the fan 22 and is rotatable independent of structures in the core engine 24. The power turbine 32 is not mechanically coupled to the core engine 24.

The fan 22 drives a bypass airflow 48 along a bypass flow path B, while the compressor section 26 draws an inlet flow 40 through an inlet duct 110 (FIG. 1) and along a core flow path C. The inlet flow 40 is turned 180 degrees into the compressor section 26 by the inlet duct 110. The inlet flow 40 is compressed and communicated to the combustor section 28 where the compressed inlet flow 40 is mixed with a fuel flow 44 and ignited to generate the exhaust gas flow 42. The exhaust gas flow 42 expands through the turbine section 30 where energy is extracted and utilized to drive the compressor section 26. The exhaust gas flow 42 further expands through the power turbine 32 to drive the fan 22.

In addition to the fuel 44, a steam flow 46 is introduced into the combustor 28. The steam flow 46 may be injected at the combustor 28 or a location upstream of the combustor for communication into the combustor 28. Performance is improved with the injection of the steam flow 46 because the steam flow 46 increases mass flow through the turbine section 30 without additional work required by the compressor section 26.

A fuel system 34 includes at least a fuel tank 36 and a fuel pump 38 to provide the fuel flow 44 to the combustor 28. The example fuel system 34 is configured to provide a hydrogen based fuel such as a liquid hydrogen (LH₂). Although hydrogen is disclosed by way of example, other non-carbon based fuels could be utilized and are within the contemplation of this disclosure. Moreover, the disclosed features may also be beneficial in an engine configured to operate with traditional carbon fuels and/or biofuels, such as sustainable aviation fuel.

The example propulsion system 20 may further include an intercooler 58 for injecting an intercooling water flow 60 into the compressor section 26 to reduce a temperature of the inlet airflow 40 and increase mass flow. Reduced temperatures and increased mass flow provided by injection of water increases compressor efficiency.

Although an example engine architecture is disclosed by way of example, other turbine engine architectures are within the contemplation and scope of this disclosure. Moreover, although the disclosed non-limiting embodiment depicts a turbofan turbine engine, it should be understood that the concepts described herein are not limited to use with turbofans as the teachings may be applied to other types of turbine engines. Additionally, the features of this disclosure may be applied to other engine configurations utilized to generate shaft power.

The condenser assembly 78 includes a plurality of condenser pairs 80, water separators 82, and a water storage tank 54. The water storage tank 54 provides for the accumulation of a volume of water required for production of sufficient amounts of steam. A mixture of water and gas 52 is emitted from the condensers 80 and communicated to the corresponding water separator 82. In the water separators 82, water 50 is separated from a gas flow 90. The water 50 recovered from the exhaust gas flow 42 is pressurized by a water pump 56 to provide a pressurized water flow 62 to the evaporator system 64. The water flow 60 may also be separately supplied to the intercooler 58 for cooling the core flow through the compressor section 26.

The example condensers 80 are arranged within the nacelle 18 circumscribing the propulsive fan 22 and the core engine 24. The nacelle 18 includes cooling air duct 88 for directing a portion of the bypass flow 48 as a cooling flow 86 to the condensers 80. A portion of the bypass flow 48 is further routed through the inlet duct 110 to the core engine 24.

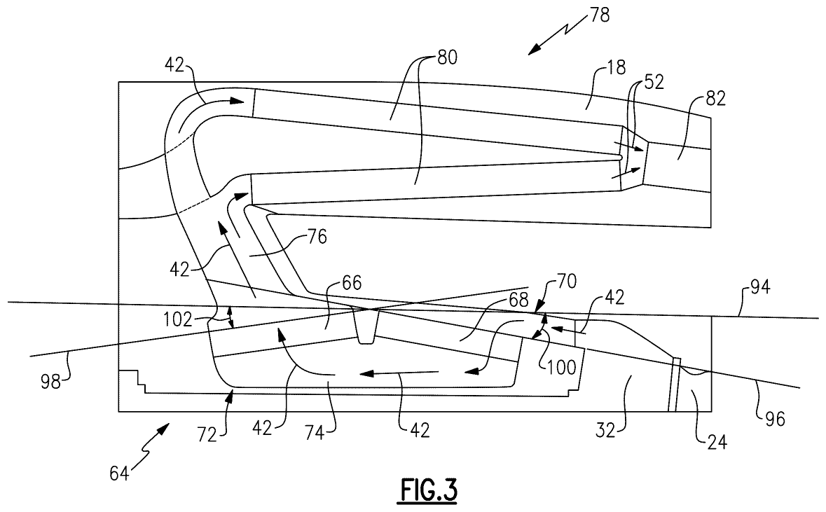

Referring to FIG. 3, with continued reference to FIGS. 1 and 2, the evaporator system 64 is arranged within an exhaust duct that is generally indicated at 72 that directs the exhaust gas flow 42 through the first and second stages 66, 68. The first and second stages 66, 68 are disposed within a central portion 74 of the exhaust duct 72. The central portion 74 of the exhaust duct 72 is supported within the IFS 70 of the propulsion system 20.

The first stage 66 and the second stage 68 are heat exchangers that are configured to provide thermal communication between a flow of recovered water and the exhaust gas flow 42. The first stage 66 is downstream of the second stage 68 in view of the exhaust gas flow 42. Accordingly, the temperature of the exhaust gas flow 42 is higher through the second stage 68 as compared to the gas flow through the first stage 66. The first stage 66 receives the water flow prior to the second stage 68. A water flow through the first stage 66 as shown in FIG. 1 is heated and may be substantially vaporized before being communicated to the second stage 68. In the second stage 68, additional heat is applied to completely vaporize the water or superheat a steam flow.

Accordingly, in one example embodiment, when the first stage 66 heats water sufficiently to create a substantially complete steam flow, the second stage 68 operates as a superheater to further heat a steam flow. If the first stage 66 does not sufficiently heat the water to generate a steam flow, the second stage 68 may operate as an additional evaporator to complete vaporization to generate the steam flow 46 that is communicated to the core engine 24.

The route of the exhaust gas flow 42 first proceeds radially inward through the second stage 68 into the central portion 74 of the exhaust duct 72. The exhaust gas flow 42 is then routed radially outward through the first stage 66 and into the radial portion 76. The route for the exhaust gas flow 42 is provided by the relative orientation of the first stage 66 and the second stage 68. In the example embodiment, the first stage 66 and the second stage 68 are angled relative to a longitudinal axis 94 that is substantially parallel to the engine axis A. The direction of incoming exhaust gas flow 42 is substantially along the axis 94 in this example embodiment. The angled orientation of the first and second stages 66, 68 encourage the direction of flow first radially inward, then radially outward.

In one example embodiment, the first stage 66 is aligned along a first evaporator plane 98 that is disposed at a first angle 102 relative to the axis 94. The second stage 68 is aligned along a second evaporator plane 96 disposed at a second angle 100 relative to the axis 94. The first angle 102 provides for a slant of the first stage 66 in a first direction and a slant of the second stage 68 in a second direction opposite the first stage 66. The resulting flow path for the exhaust gas flow 42 through the central portion 74 is generally “S” shaped first flowing radially inward through the second stage 68 and then radially outward through the first stage 66. The angled orientation provides an efficient flow path for turning the exhaust gas flow 42 through the stages 66, 68 and toward the condensers 80.

Exhaust gas flow 42 emitted from the first stage 66 flows radially outward through the radial portion 76 of the exhaust gas duct 72 toward the condensers 80. The example condensers 80 are arranged in pairs and each receive a portion of the exhaust gas flow 42. Although the example condensers 80 are arranged in pairs and shown in a relative orientation within the nacelle 18, other arrangements and orientations of the condensers 80 and condenser assembly 78 could be utilized and are within the contemplation and scope of this disclosure.

In one disclosed example, the radial portion 76 of the exhaust gas duct 72 splits the exhaust gas flow 42 and turns it axially into each of the condensers 80. In each of the condensers 80, the exhaust gas flow 42 is cooled such that water condenses and is communicated further aft into one of a plurality of water separators 82. From the water separators 82, water is communicated to the water tank 54 and a remaining gas flow 90 is exhausted through a nozzle 92 at an aft end of the nacelle 18 as shown in FIG. 1.

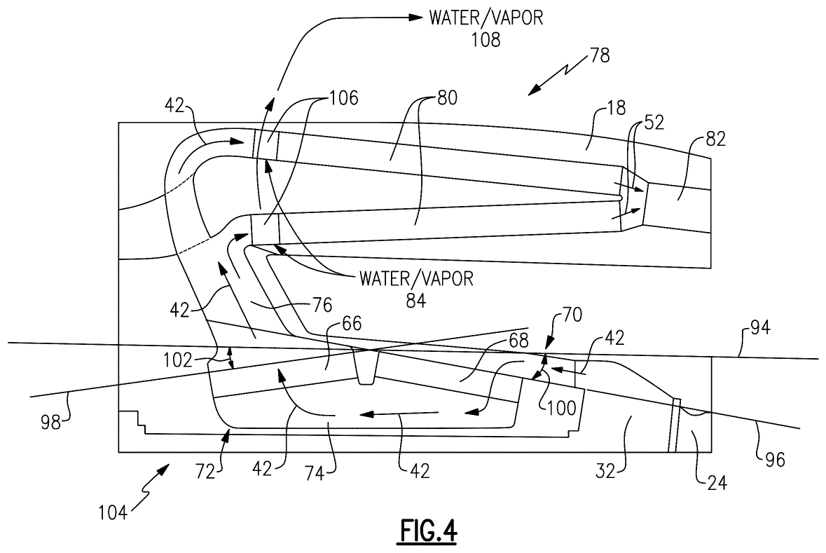

Referring to FIG. 4, another evaporator system 104 is schematically shown and includes outer stages 106. The outer stages 106 are disposed radially outward of the central portion 74 of the exhaust duct 72 and the first and second stages 66, 68. In one disclosed example the outer stages 106 correspond with each of the condensers 80. The outer stages 106 receive a flow 84 that may be water, vapor, or water/vapor mixture. The flow 84 may be directly from the water tank 54 or from one of the first and second stages 66, 68. The flow 84 is heated with exhaust gas 42 that was previously emitted from the first stage 66 and communicated through the radial portion 76 of the exhaust duct 72. The outer stages 106 supplement heat input provided by the first and second stages 66, 68. A flow 108 is output from each of the outer stages 106. The flow 108 maybe heated water, vapor or a mixture of water/vapor depending on the condition of the input flow 84 and available thermal energy in the exhaust gas flow 42 after the first and second stages 66, 68.

The outer stages 106 are shown schematically and are heat exchangers that provide for thermal communication between the flow 84 and the exhaust gas flow 42. The size and shape of the outer stages 106 may be larger or smaller than shown and shaped to fit within the space available within the nacelle 18. Moreover, although one outer stage 106 is shown for each condenser 80, an outer stage 106 may correspond with a pair of condensers 80 that are in communication with one of the radial portions 76. The example outer stages 106 provide for the advantageous use of space within the exhaust duct 72 for supplementing thermal input for heating and vaporizing recovered water.

Accordingly, the disclosed evaporator systems 64, 104 include multiple stages 66, 68, and 106 that are arranged to maximize thermal transfer areas within the limited space available within the propulsion system 20.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. An aircraft propulsion system comprising:
a core engine comprising a compressor, combustor, and turbine section, wherein an inlet airflow is compressed communicated to the combustor, mixed with fuel, and ignited to generate an exhaust gas flow that is expanded through the turbine section;
a propulsor driven about a propulsor axis by the core engine;
an exhaust duct defining a flow path for the exhaust gas flow, the exhaust duct comprising a central portion and at least one radial portion;
a condenser assembly where water is condensed from the exhaust gas flow received through the exhaust duct; and
an evaporator system where heat from the exhaust gas flow is used to transform water from the condenser assembly into a steam flow for communication to the core engine, the evaporator system comprising a first stage separate from a second stage disposed within the central portion of the exhaust duct.

2. The aircraft propulsion system as recited in claim 1, wherein the first stage is disposed within a first evaporator plane that is disposed at a first angle relative to an engine longitudinal axis.

3. The aircraft propulsion system as recited in claim 2, wherein the second stage is disposed at a second angle relative to the engine longitudinal axis, the first angle is different than the second angle.

4. The aircraft propulsion system as recited in claim 1, further comprising an inner fixed structure and the central portion of the exhaust duct comprising the first stage and the second stage of the evaporator system is disposed within the inner fixed structure.

5. The aircraft propulsion system as recited in claim 1, wherein a flow path for the exhaust gas flow within the central portion of the exhaust duct comprises a first radial direction through the second stage and a second radial direction portion through the first stage.

6. The aircraft propulsion system as recited in claim 1, wherein the second stage comprises a superheater where a steam flow is heated by the exhaust gas flow.

7. The aircraft propulsion system as recited in claim 1, wherein the evaporator system further comprises an outer stage for heating water recovered from the exhaust gas flow, the outer stage spaced radially apart from the first stage and the second stage.

8. The aircraft propulsion system as recited in claim 1, wherein the condenser assembly comprises a plurality of condenser pairs where water is condensed from an exhaust gas flow.

9. The aircraft propulsion system as recited in claim 8, comprising a cooling air duct assembly where a portion of inlet airflow is communicated to each of the plurality of condenser pairs.

10. The aircraft propulsion system as recited in claim 8, further comprising a nacelle assembly disposed about the propulsor and the core engine, wherein the plurality of condenser pairs is supported within the nacelle.

11. The aircraft propulsion system as recited in claim 1, further comprising a plurality of water separators where water from the condenser assembly is separated from the exhaust gas flow.

12. The aircraft propulsion system as recited in claim 1, wherein the turbine section of the core engine is engine forward of the combustor and the compressor section and an inlet duct assembly communicates a portion of the inlet airflow to an inlet that is disposed aft of the compressor section.

13. The aircraft propulsion system as recited in claim 12, further comprising a power turbine coupled to drive the propulsor, the power turbine disposed engine forward of the core engine.

14. A steam generation system for an aircraft propulsion system comprising:
an exhaust duct comprising a central portion and at least one radial portion defining a flow path for an exhaust gas flow;
a condenser assembly where water is condensed from the exhaust gas flow received through the exhaust duct; and
an evaporator system where heat from the exhaust gas flow is used to transform water from the condenser assembly into a steam flow for communication to a core engine flow path, the evaporator system comprising a first stage separate from a second stage disposed within the exhaust duct.

15. The steam generation system in claim 14, wherein a flow path for the exhaust gas flow comprises a first radial direction communicating exhaust gas flow through the second stage and a second radial direction through the first stage, wherein the first radial direction is opposite the second radial direction.

16. The steam generation system as recited in claim 15, wherein the second stage comprises a superheater where a steam flow is heated by the exhaust gas flow.

17. The steam generation system as recited in claim 15, wherein the evaporator system further comprises an outer stage for heating water recovered from the exhaust gas flow, the outer stage spaced radially apart from the first stage and the second stage.

18. The steam generation system as recited in claim 14, wherein the condenser assembly comprises a plurality of condenser pairs where water is condensed from an exhaust gas flow.

19. A method of operating an aircraft propulsion system comprising:
generating an exhaust gas flow with a core engine comprising a compressor, combustor, and turbine section;
coupling a propulsor to a power turbine configured to be driven by expansion of the exhaust gas flow about a propulsor axis by the core engine;
condensing water in condenser assembly;
heating water from the condenser assembly in a first stage of an evaporator system with heat from the exhaust gas flow that is routed through a portion of an exhaust duct supported within an inner fixed structure;
further heating a flow of heated water from the first stage of the evaporator system in a separate second stage of the evaporator assembly to generate a steam flow, wherein the second stage receives the exhaust gas flow before the first stage; and
communicating the generated steam flow to the core engine.

20. The method as recited in claim 19, comprising further heating the steam flow or the water flow in an outer stage that is radially spaced apart from the first stage and the second stage.
